(19) United States
(12) Patent Application Publication
(10) Pub. No.: US 2023/0259965 A1
(43) Pub. Date: Aug. 17, 2023

(54) SYSTEM AND METHOD FOR AUTOMATING SPONSORED-SEARCH DATA PIPELINES

(71) Applicant: JPMorgan Chase Bank, N.A., New York, NY (US)

(72) Inventors: Neil STEINER, North Salem, NY (US); Mark LI, Rockville, MD (US); Rahul POKHARNA, Manhattan, NY (US); Gil FISHMAN, Kings, NY (US); Kevin FISCHER, Hoboken, NJ (US)

(73) Assignee: JPMorgan Chase Bank, N.A., New York, NY (US)

(21) Appl. No.: 18/100,881

(22) Filed: Jan. 24, 2023

Related U.S. Application Data
(60) Provisional application No. 63/268,029, filed on Feb. 15, 2022.

(51) Int. Cl. G06Q 30/0242; G06Q 30/0273

(52) U.S. Cl. CPC G06Q 30/0242; G06Q 30/0275

(57) ABSTRACT

Various methods, apparatuses/systems, and media for automating sponsored-search data pipelines are disclosed. A processor generates keyword-level metrics data based on received bidder input data that includes cost-per-acquisition (CPA) data and total spending data for each keyword; determines campaign-level CPA threshold data chosen at previous iteration of search campaign and a target CPA data used for current search campaign; calculates, campaign-level metrics data that includes the CPA data and adjusted total spending data; quantifies a final campaign-level reward data based on the calculated campaign-level metrics data, adjusted total spending data, and the target CPA data; updates a distribution corresponding to CPA-threshold data chosen at previous iteration using the final campaign-level reward data; samples CPA-threshold distributions and determines CPA-threshold data chosen at current iteration; executes campaign-level heuristics using the keyword-level metrics data, campaign-level metrics data, and the CPA-threshold data chosen at current iteration; and displaying final heuristic-execution data onto a GUI.

### CROSS-REFERENCE TO RELATED APPLICATIONS

This application claims the benefit of priority from U.S. Provisional Patent Application No. 63/268,029, filed Feb. 15, 2022, which is herein incorporated by reference in its entirety.

### TECHNICAL FIELD

This disclosure generally relates to sponsored-search data pipelines, and, more particularly, to methods and apparatuses for implementing a multi-armed bandit application module for applying multi-armed bandit algorithms for automating sponsored-search data pipelines, thereby allowing different sponsored search heuristics to be automated and scaled in a robust fashion.

### BACKGROUND

The developments described in this section are known to the inventors. However, unless otherwise indicated, it should not be assumed that any of the developments described in this section qualify as prior art merely by virtue of their inclusion in this section, or that those developments are known to a person of ordinary skill in the art.

Today, a wide variety of business functions are commonly supported by software applications and tools, i.e., business intelligence (BI) tools. For instance, software has been directed to data monitoring, performance analysis, project tracking, and competitive analysis, to name but a few. Online search driven by Web-based search engines may be an important use of computer networks such as the Internet. Computer users can employ a variety of search tools to search for content using different user interfaces and search methods.

In general, sponsored-search data pipelines may provide a workable business model for meta-search engines, which are extremely beneficial for searches needing high recall and requiring a thorough coverage of a topic. Sponsored-search data pipelines may provide an effective method for overcoming the inherent biases in the technical implementation of particular web search engines as well by allowing content providers to move their links to the first Search Engine Results Page (SERP) at relatively low cost. In doing so, sponsored search may prove to be an essential tool vital to the success of many businesses. Thus, automating sponsored-search data pipelines is very important for many businesses to succeed. However, conventional tools lack the capabilities of automating the sponsored-search data pipelines.

For example, to automate bidding for search campaigns, conventional Google's automated bidding solution (i.e., Google's bidder) may be utilized by computer users. Google's automated bidding solution, however, may prove to be a black-box algorithm that is unable to leverage the domain knowledge of a paid media team. Google's automated bidding solution is also very volatile and does not produce consistent results. A paid media is one method available today by which organizations may promote their content through sponsored social media posts, display ads, paid search results, video ads, pop-ups (i.e., sponsored-search), etc. The paid media team may have domain knowledge about a sponsored search space that may allow them to manually produce bid prices that may be more optimal than Google's automated bidding solution. However, the paid media team does not have the ability to scale these bid prices as well as Google's bidder.

In addition, multi-armed bandit algorithms are a type of reinforcement learning algorithm that may allow for reinforcement learning to be performed in many real-world scenarios. However, these algorithms are not generally suited for very complex problems because of their algorithmic simplicity, thereby failing to provide meaningful solution for automating and scaling different sponsored search heuristics.

Thus, there is a need for an advanced tool that can address these conventional shortcomings.

### SUMMARY

The present disclosure, through one or more of its various aspects, embodiments, and/or specific features or sub-components, provides, among other features, various systems, servers, devices, methods, media, programs, and platforms for implementing a platform and language agnostic multi-armed bandit application module for applying multi-armed bandit algorithms for automating sponsored-search data pipelines, thereby allowing different sponsored search heuristics to be automated and scaled in a robust fashion, but the disclosure is not limited thereto. For example, the present disclosure, through one or more of its various aspects, embodiments, and/or specific features or sub-components, may also provide, among other features, various systems, servers, devices, methods, media, programs, and platforms for implementing a platform and language agnostic multi-armed bandit application module that allows for applying multi-armed bandit algorithms to more complex problems, such as sponsored search, by having the multi-armed bandit adjust data pipeline parameters instead of directly trying to solve the problem, thereby automating the sponsored-search data pipelines or automating the adjustment of data pipelines in any other desired marketing channels (i.e., direct-mail data pipeline), but the disclosure is not limited thereto.

According to an aspect of the present disclosure, a method for automating sponsored-search data pipelines by utilizing one or more processors along with allocated memory is disclosed. The method may include: receiving bidder input data in a sponsored-search data pipeline; generating keyword-level metrics data based on the received bidder input data that includes cost-per-acquisition (CPA) data and total spending data for each keyword; determining campaign-level CPA threshold data chosen at previous iteration of search campaign and target CPA data used for current search campaign; calculating, in response to determining, campaign-level metrics data that includes the CPA data and adjusted total spending data; quantifying, in response to calculating, a final campaign-level reward data based on the calculated campaign-level metrics data, adjusted total spending data, and the target CPA data; updating, in response to quantifying, a distribution corresponding to CPA-threshold data chosen at previous iteration using the final campaign-level reward data; sampling CPA-threshold distributions and determining CPA-threshold data chosen at current iteration; executing, in response to sampling, campaign-level heuristics using the keyword-level metrics data, campaign-level metrics data, and the CPA-threshold data chosen at current iteration; and displaying the final heuristic-execution data onto a graphical user interface (GUI), thereby automating the sponsored-search data pipeline.

According to yet another aspect of the instant disclosure, the bidder input data may include hourly update data corresponding to keyword-level campaign data, and the method may further include: generating bad keyword heuristic data and good keyword heuristic data based on determining that there is a click for a certain keyword and that there is a conversion of said certain keyword; generating no-click heuristic data based on determining that there is no click for the certain keyword; generating click-only heuristic data based on determining that there is a click for the certain keyword, but there is no conversion for the certain keyword; generating keyword bids data based on weighted value of each of the bad keyword heuristic data, good keyword heuristic data, no-click heuristic data, and click-only heuristic data; and applying the keywords bids data in calculating the final heuristic-execution data.

According to a further aspect of the instant disclosure, the bidder input data may include daily update data corresponding to geo level campaign data, audience level campaign data, and device level campaign data, and the method may further include: utilizing the geo level campaign data to generate geo heuristic data; utilizing the audience level campaign data to generate audience heuristic data; and utilizing the device level campaign data to generate device heuristic data.

According to another aspect of the present disclosure, the method may further include generating a geo modifier data based on a weighted value of the geo heuristic data; generating an audience modifier data based on a weighted value of the audience heuristic data; generating a device modifier data based on a weighted value of the device heuristic data; and applying the geo modifier data, the audience modifier data, and the device modifier data along with the keyword bids data in calculating the final heuristic-execution data.

According to an additional aspect of the instant disclosure, the adjusted total spending data may correspond to total under threshold keywords' spending data or total converted keyword spending data.

According to yet another aspect of the instant disclosure, the target CPA data may be set as a guideline for a profitable CPA initiated at campaign level by a line-of-business (LOB) based on product profitability.

According to a further aspect of the instant disclosure, the CPA threshold data may be set as a value representing a percentile of all keywords' CPAs under the same search campaign.

According to another aspect of the instant disclosure, in calculating the final campaign-level reward data, the method may further include: placing previously calculated campaign-level metrics data as a point on a quadrant space formed by the CPA as a first axis of the quadrant and the adjusted total spending data as a second axis of the quadrant orthogonal to the first axis; placing the target CPA data as an intersected line with the first axis on the quadrant; and calculating the final campaign-level reward data that represents a rectangular area formed by drawing orthogonal lines from the point to both the first axis and the intersected line.

According to an additional aspect of the instant disclosure, the method may further include: utilizing the calculated final campaign-level reward data to update corresponding previously used CPA threshold's reward distribution; sampling reward from each CPA threshold arm's posterior distribution and argmax to select a threshold with the largest reward; and setting this selected threshold as a fixed strategy for next iteration for search.

According to an aspect of the present disclosure, a system for automating sponsored-search data pipelines is disclosed. The system may include: a processor; and a memory operatively connected to the processor via a communication interface, the memory storing computer readable instructions, when executed, may cause the processor to: receive bidder input data in a sponsored-search data pipeline; generate keyword-level metrics data based on the received bidder input data that includes CPA data and total spending data for each keyword; determine campaign-level CPA threshold data chosen at previous iteration of search campaign and a target CPA data used for current search campaign; calculate, in response to determining, campaign-level metrics data that includes the CPA data and adjusted total spending data; quantify, in response to calculating, a final campaign-level reward data based on the calculated campaign-level metrics data, adjusted total spending data, and the target CPA data; update, in response to quantifying, a distribution corresponding to CPA-threshold data chosen at previous iteration using the final campaign-level reward data; sample CPA-threshold distributions and determine CPA-threshold data chosen at current iteration; execute, in response to sampling, campaign-level heuristics using the keyword-level metrics data, campaign-level metrics data, and the CPA-threshold data chosen at current iteration; and displaying the final heuristic-execution data onto a GUI, thereby automating the sponsored-search data pipeline or automating the adjustment of data pipelines in any other desired marketing channels.

According to yet another aspect of the instant disclosure, the bidder input data may include hourly update data, real-time update data, or other preconfigured time-based update data corresponding to keyword-level campaign data, and the processor may be further configured to: generate bad keyword heuristic data and good keyword heuristic data based on determining that there is a click for a certain keyword and that there is a conversion of said certain keyword; generate no-click heuristic data based on determining that there is no click for the certain keyword; generate click-only heuristic data based on determining that there is a click for the certain keyword, but there is no conversion for the certain keyword; generate keyword bids data based on weighted value of each of the bad keyword heuristic data, good keyword heuristic data, no-click heuristic data, and click-only heuristic data; and apply the keywords bids data in calculating the final heuristic-execution data.

According to a further aspect of the instant disclosure, the bidder input data may include daily update data, real-time update data, or other preconfigured time-based update data corresponding to geo level campaign data, audience level campaign data, and device level campaign data, and the processor may be further configured to: utilize the geo level campaign data to generate geo heuristic data; utilize the audience level campaign data to generate audience heuristic data; and utilize the device level campaign data to generate device heuristic data.

According to an aspect of the present disclosure, the processor may be further configured to generate a geo modifier data based on a weighted value of the geo heuristic data; generate an audience modifier data based on a weighted value of the audience heuristic data; generate a device modifier data based on a weighted value of the device heuristic data; and apply the geo modifier data, the audience modifier data, and the device modifier data along with the keyword bids data in calculating the final heuristic-execution data.

According to another aspect of the instant disclosure, in calculating the final campaign-level reward data, the processor may be further configured to: place previously calculated campaign-level metrics data as a point on a quadrant space formed by the CPA as a first axis of the quadrant and the adjusted total spending data as a second axis of the quadrant orthogonal to the first axis; place the target CPA data as an intersected line with the first axis on the quadrant; and calculate the final campaign-level reward data that represents a rectangular area formed by drawing orthogonal lines from the point to both the first axis and the intersected line.

According to an additional aspect of the instant disclosure, the processor may be further configured to: utilize the calculated final campaign-level reward data to update corresponding previously used CPA threshold's reward distribution; sample reward from each CPA threshold arm's posterior distribution and argmax to select a threshold with the largest reward; and set this selected threshold as a fixed strategy for next iteration for search.

According to yet another aspect of the present disclosure, a non-transitory computer readable medium configured to store instructions for automating sponsored-search data pipelines is disclosed. The instructions, when executed, may cause a processor to perform the following: receiving bidder input data in a sponsored-search data pipeline; generating keyword-level metrics data based on the received bidder input data that includes CPA data and total spending data for each keyword; determining campaign-level CPA threshold data chosen at previous iteration of search campaign and a target CPA data used for current search campaign; calculating, in response to determining, campaign-level metrics data that includes the CPA data and adjusted total spending data; quantifying, in response to calculating, a final campaign-level reward data based on the calculated campaign-level metrics data, adjusted total spending data, and the target CPA data; updating, in response to quantifying, a distribution corresponding to CPA-threshold data chosen at previous iteration using the final campaign-level reward data; sampling CPA-threshold distributions and determine CPA-threshold data chosen at current iteration; executing, in response to sampling, campaign-level heuristics using the keyword-level metrics data, campaign-level metrics data, and the CPA-threshold data chosen at current iteration; and displaying the final heuristic-execution data onto a GUI, thereby automating the sponsored-search data pipeline or automating the adjustment of data pipelines in any other desired marketing channels.

According to yet another aspect of the instant disclosure, the bidder input data may include hourly update data, real-time update data, or other preconfigured time-based update data corresponding to keyword-level campaign data, and the instructions, when executed, may cause the processor to further perform the following: generating bad keyword heuristic data and good keyword heuristic data based on determining that there is a click for a certain keyword and that there is a conversion of said certain keyword; generating no-click heuristic data based on determining that there is no click for the certain keyword; generating click-only heuristic data based on determining that there is a click for the certain keyword, but there is no conversion for the certain keyword; generating keyword bids data based on weighted value of each of the bad keyword heuristic data, good keyword heuristic data, no-click heuristic data, and click-only heuristic data; and applying the keywords bids data in calculating the final heuristic-execution data.

According to a further aspect of the instant disclosure, the bidder input data may include daily update data, real-time update data, or other preconfigured time-based update data corresponding to geo level campaign data, audience level campaign data, and device level campaign data, and the instructions, when executed, may cause the processor to further perform the following: utilizing the geo level campaign data to generate geo heuristic data; utilizing the audience level campaign data to generate audience heuristic data; and utilizing the device level campaign data to generate device heuristic data.

According to an aspect of the present disclosure, the instructions, when executed, may cause the processor to further perform the following generating a geo modifier data based on a weighted value of the geo heuristic data; generating an audience modifier data based on a weighted value of the audience heuristic data; generating a device modifier data based on a weighted value of the device heuristic data; and applying the geo modifier data, the audience modifier data, and the device modifier data along with the keyword bids data in calculating the final heuristic-execution data.

According to another aspect of the instant disclosure, in calculating the final campaign-level reward data, the instructions, when executed, may cause the processor to further perform the following: placing previously calculated campaign-level metrics data as a point on a quadrant space formed by the CPA as a first axis of the quadrant and the adjusted total spending data as a second axis of the quadrant orthogonal to the first axis; placing the target CPA data as an intersected line with the first axis on the quadrant; and calculating the final campaign-level reward data that represents a rectangular area formed by drawing orthogonal lines from the point to both the first axis and the intersected line.

According to an additional aspect of the instant disclosure, the instructions, when executed, may cause the processor to further perform the following: utilizing the calculated final campaign-level reward data to update corresponding previously used CPA threshold's reward distribution; sampling reward from each CPA threshold arm's posterior distribution and argmax to select a threshold with the largest reward; and setting this selected threshold as a fixed strategy for next iteration for search.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a platform and language agnostic multi-armed bandit application module that may be configured for automating sponsored-search data pipelines in accordance with an exemplary embodiment.

FIG. 2 illustrates an exemplary diagram of a network environment with a platform and language agnostic multi-armed bandit application device in accordance with an exemplary embodiment.

FIG. 3 illustrates a system diagram for implementing a platform and language agnostic multi-armed bandit application device having a platform and language agnostic multi-armed bandit application module in accordance with an exemplary embodiment.

FIG. 4 illustrates a system diagram for implementing a platform and language agnostic multi-armed bandit application module of FIG. 3 in accordance with an exemplary embodiment.

FIG. 5 illustrates an exemplary architecture implemented by the platform and language agnostic multi-armed bandit application module of FIG. 4 in accordance with an exemplary embodiment.

FIG. 6 illustrates an exemplary final campaign-level reward calculated by the platform and language agnostic multi-armed bandit application module of FIG. 4 in accordance with an exemplary embodiment.

FIG. 7 illustrates an exemplary graph that shows how a CPA threshold is set as the fixed strategy for next iteration of search campaign by the platform and language agnostic multi-armed bandit application module of FIG. 4 in accordance with an exemplary embodiment.

FIG. 8 illustrates an exemplary flow chart implemented by the platform and language agnostic multi-armed bandit application module of FIG. 4 for automating sponsored-search data pipelines in accordance with an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

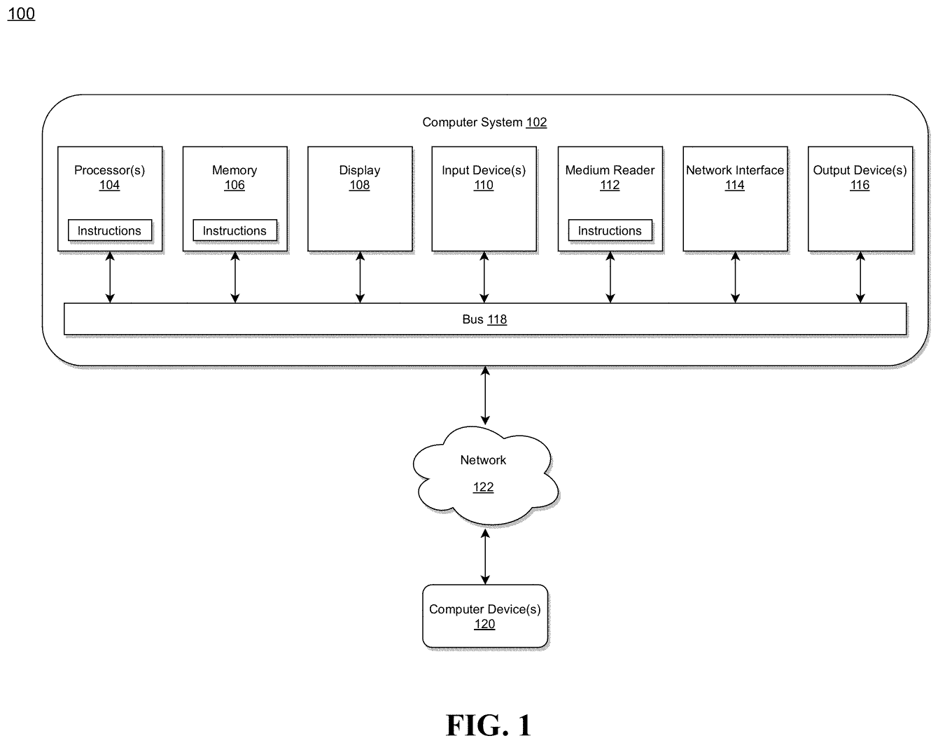

FIG. 1 is an exemplary system 100 for use in implementing a platform and language agnostic multi-armed bandit application module that may be configured for automating sponsored-search data pipelines in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

According to exemplary embodiments, the multi-armed bandit application module may be platform and language agnostic that may allow for consistent easy orchestration and passing of data through various components to output a desired result. Since the disclosed process, according to exemplary embodiments, is platform and language agnostic, the multi-armed bandit application module may be independently tuned or modified for optimal performance without affecting the configuration or data files. The configuration or data files, according to exemplary embodiments, may be written using JSON, but the disclosure is not limited thereto. For example, the configuration or data files may easily be extended to other readable file formats such as XML, YAML, etc., or any other configuration-based languages. For example, the data files may easily be extended to other files formats such as CSV, RDF, OWL, etc., or any other structured, semi-structured, or unstructured format

In accordance with various embodiments of the present disclosure, the methods described herein may be implemented using a hardware computer system that executes software programs. Further, in an exemplary, non-limited embodiment, implementations can include distributed processing, component/object distributed processing, and an operation mode having parallel processing capabilities. Virtual computer system processing can be constructed to implement one or more of the methods or functionalities as described herein, and a processor described herein may be used to support a virtual processing environment.

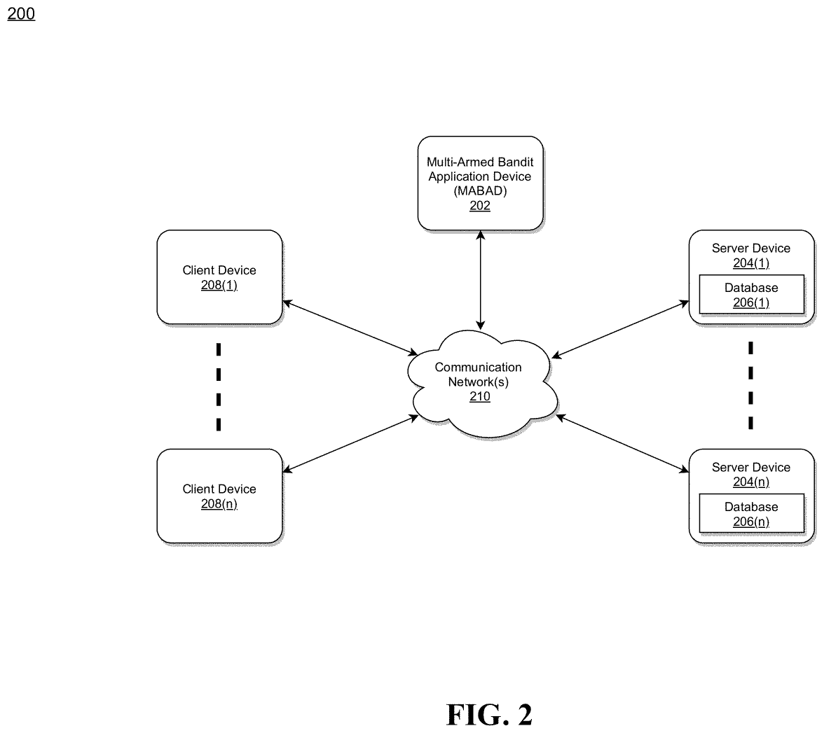

Referring to FIG. 2, a schematic of an exemplary network environment 200 for implementing a platform and language multi-armed bandit application device (MABAD) of the instant disclosure is illustrated.

According to exemplary embodiments, the above-described problems associated with conventional tools may be overcome by implementing a MABAD 202 as illustrated in FIG. 2 that may be configured for applying multi-armed bandit algorithms for automating sponsored-search data pipelines, thereby allowing different sponsored search heuristics to be automated and scaled in a robust fashion, but the disclosure is not limited thereto. For example, according to exemplary embodiments, the above-described problems associated with conventional tools may be overcome by implementing an MABAD 202 as illustrated in FIG. 2 that may be configured for applying multi-armed bandit algorithms to more complex problems, such as sponsored search, by having the multi-armed bandit adjust data pipeline parameters instead of directly trying to solve the problem, thereby automating the sponsored-search data pipelines or automating the adjustment of data pipelines in other desired marketing channels, but the disclosure is not limited thereto.

The MABAD 202 may be the same or similar to the computer system 102 as described with respect to FIG. 1.

The MABAD 202 may store one or more applications that can include executable instructions that, when executed by the MABAD 202, cause the MABAD 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the MABAD 202 itself, may be located in virtual server(s) running in a cloud-based computing environment rather than being tied to one or more specific physical network computing devices. Also, the application(s) may be running in one or more virtual machines (VMs) executing on the MABAD 202. Additionally, in one or more embodiments of this technology, virtual machine(s) running on the MABAD 202 may be managed or supervised by a hypervisor.

In the network environment 200 of FIG. 2, the MABAD 202 is coupled to a plurality of server devices 204(1)-204(n) that hosts a plurality of databases 206(1)-206(n), and also to a plurality of client devices 208(1)-208(n) via communication network(s) 210. A communication interface of the MABAD 202, such as the network interface 114 of the computer system 102 of FIG. 1, operatively couples and communicates between the MABAD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the MABAD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 202 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The MABAD 202 may be a standalone device or integrated with one or more other devices or apparatuses, such as one or more of the server devices 204(1)-204(n), for example. In one particular example, the MABAD 202 may be hosted by one of the server devices 204(1)-204(n), and other arrangements are also possible. Moreover, one or more of the devices of the MABAD 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the MABAD 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store metadata sets, data quality rules, and newly generated data, but the disclosure is not limited thereto. For example, the database(s) 206(1)-206(n) may be a mainframe database, a log database that may produce programming for searching, monitoring, and analyzing machine-generated data via a web interface, etc., but the disclosure is not limited thereto. The database(s) 206(1)-206(n) may also include relational databases and NoSQL databases (key-value, column, document, graph, multi-model, etc.). Moreover, the MABAD 202 may be configured to leverage any database protocol (i.e., Java Database Connectivity, Open Database Connectivity, etc.) and distributed file systems for reading/writing data (i.e., Hadoop Distributed File System, Amazon Simple Storage Service, etc.).

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

According to exemplary embodiments, the client devices 208(1)-208(n) in this example may include any type of computing device that can facilitate the implementation of the MABAD 202 that may efficiently provide a platform for implementing a platform and language agnostic multi-armed bandit application module for applying multi-armed bandit algorithms for automating sponsored-search data pipelines, thereby allowing different sponsored search heuristics to be automated and scaled in a robust fashion, but the disclosure is not limited thereto. For example, according to exemplary embodiments, the client devices 208(1)-208(n) in this example may include any type of computing device that can facilitate the implementation of the MABAD 202 that may efficiently provide a platform for implementing a platform and language agnostic multi-armed bandit application module that allows for applying multi-armed bandit algorithms to more complex problems, such as sponsored search, by having the multi-armed bandit adjust data pipeline parameters instead of directly trying to solve the problem, thereby automating the sponsored-search data pipelines, but the disclosure is not limited thereto.

The client devices 208(1)-208(n) may run interface applications, such as standard web browsers or standalone client applications, which may provide an interface to communicate with the MABAD 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the MABAD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the MABAD 202, the server devices 204(1)-204(n), or the client devices 208(1)-208(n), for example, may be configured to operate as virtual instances on the same physical machine. For example, one or more of the MABAD 202, the server devices 204(1)-204(n), or the client devices 208(1)-208(n) may operate on the same physical device rather than as separate devices communicating through communication network(s) 210. Additionally, there may be more or fewer MABADs 202, server devices 204(1)-204(n), or client devices 208(1)-208(n) than illustrated in FIG. 2. According to exemplary embodiments, the MABAD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

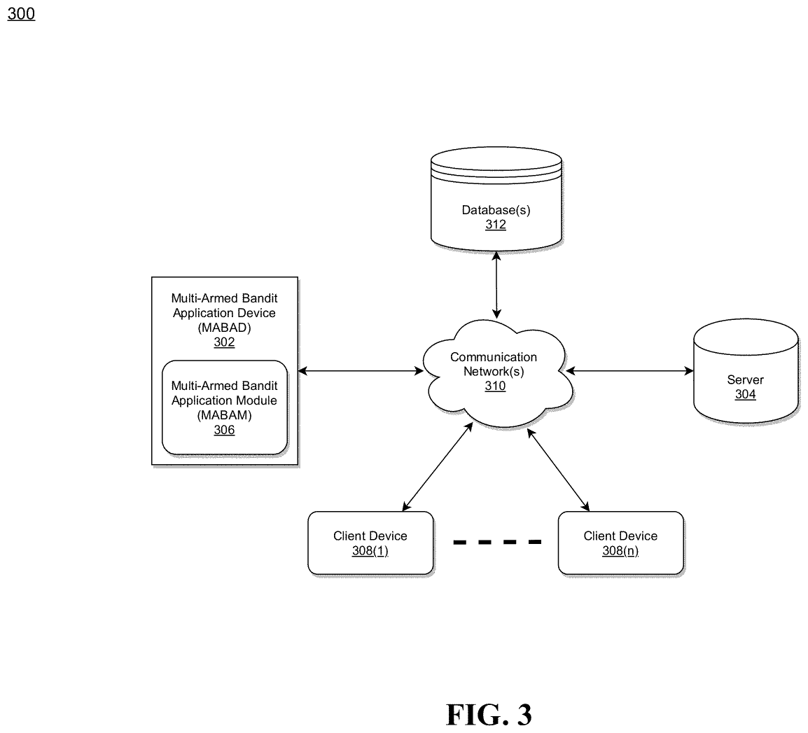

FIG. 3 illustrates a system diagram for implementing a MABAD having a platform and language agnostic multi-armed bandit application module (MABAM) in accordance with an exemplary embodiment.

As illustrated in FIG. 3, the system 300 may include a MABAD 302 within which an MABAM 306 is embedded, a server 304, a database(s) 312, a plurality of client devices 308(1) . . . 308(n), and a communication network 310.

According to exemplary embodiments, the MABAD 302 including the MABAM 306 may be connected to the server 304, and the database(s) 312 via the communication network 310. The MABAD 302 may also be connected to the plurality of client devices 308(1) . . . 308(n) via the communication network 310, but the disclosure is not limited thereto.

According to exemplary embodiment, the MABAD 302 is described and shown in FIG. 3 as including the MABAM 306, although it may include other rules, policies, modules, databases, or applications, for example. According to exemplary embodiments, the database(s) 312 may be configured to store ready to use modules written for each API for all environments. Although only one database is illustrated in FIG. 3, the disclosure is not limited thereto. Any number of desired databases may be utilized for use in the disclosed invention herein. The database(s) 312 may be a mainframe database, a log database that may produce programming for searching, monitoring, and analyzing machine-generated data via a web interface, etc., but the disclosure is not limited thereto. For example, the database(s) 312 may also include relational databases and NoSQL databases (key-value, column, document, graph, multi-model, etc.). Moreover, the MABAM 306 may be configured to leverage any database protocol (i.e., Java Database Connectivity, Open Database Connectivity, etc.) and distributed file systems for reading/writing data (i.e., Hadoop Distributed File System, Amazon Simple Storage Service, etc.).

According to exemplary embodiments, the MABAM 306 may be configured to receive real-time feed of data from the plurality of client devices 308(1) . . . 308(n), and the database(s) 312 via the communication network 310. According to exemplary embodiments, the MABAM 306 may be configured to utilize stream processing systems as the real-time feed. For example, the real-time feed(s) may be a stream processing system, such as Apache Kafka, Apache Spark, Amazon Kinesis, etc., but the disclosure is not limited thereto.

As will be described below, the MABAM 306 may be configured to: receive bidder input data for database(s) 312 in a sponsored-search data pipeline; generate keyword-level metrics data based on the received bidder input data that CPA data and total spending data for each keyword; determine campaign-level CPA threshold data chosen at previous iteration of search campaign and a target CPA data used for current search campaign; calculate, in response to determining, campaign-level metrics data that includes the CPA data and adjusted total spending data; quantify, in response to calculating, a final campaign-level reward data based on the calculated campaign-level metrics data, adjusted total spending data, and the target CPA data; update, in response to quantifying, a distribution corresponding to CPA-threshold data chosen at previous iteration using the final campaign-level reward data; sample CPA-threshold distributions and determine CPA-threshold data chosen at current iteration; execute, in response to sampling, campaign-level heuristics using the keyword-level metrics data, campaign-level metrics data, and the CPA-threshold data chosen at current iteration; and displaying the final heuristic-execution data onto a GUI, thereby automating the sponsored-search data pipeline, but the disclosure is not limited thereto.

The plurality of client devices 308(1) . . . 308(n) are illustrated as being in communication with the MABAD 302. In this regard, the plurality of client devices 308(1) . . . 308(n) may be “clients” (e.g., customers) of the MABAD 302 and are described herein as such. Nevertheless, it is to be known and understood that the plurality of client devices 308(1) . . . 308(n) need not necessarily be “clients” of the MABAD 302, or any entity described in association therewith herein. Any additional or alternative relationship may exist between either or both of the plurality of client devices 308(1) . . . 308(n) and the MABAD 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. According to exemplary embodiments, the server 304 may be the same or equivalent to the server device 204 as illustrated in FIG. 2.

The process may be executed via the communication network 310, which may comprise plural networks as described above. For example, in an exemplary embodiment, one or more of the plurality of client devices 308(1) . . . 308(n) may communicate with the MABAD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The MABAD 302 may be the same or similar to the MABAD 202 as described with respect to FIG. 2, including any features or combination of features described with respect thereto.

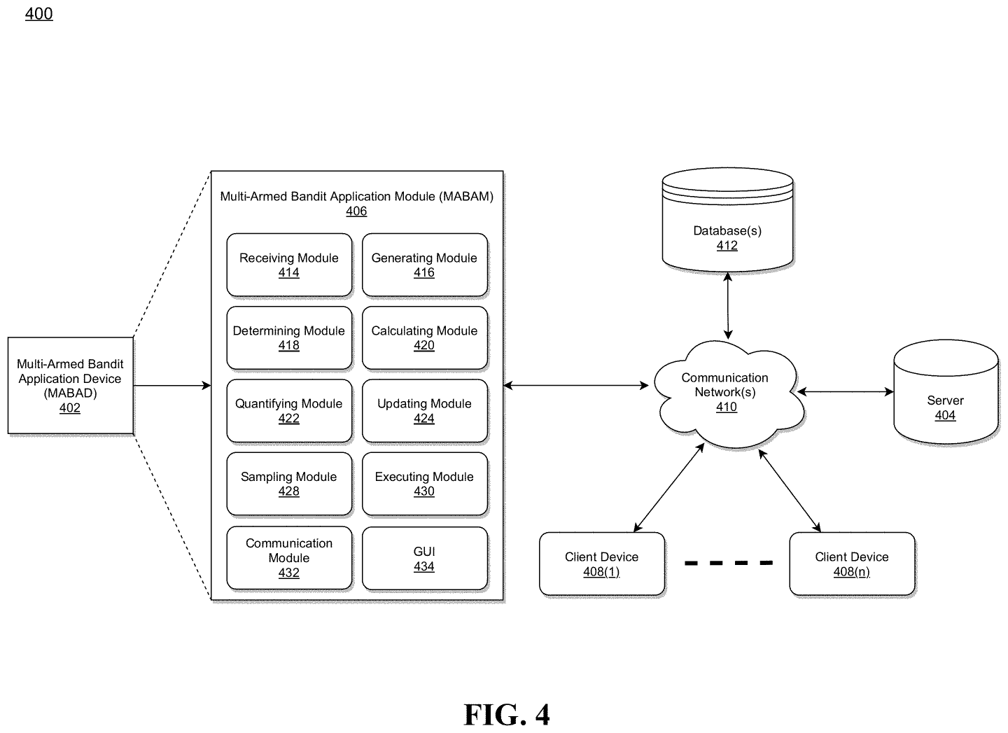

FIG. 4 illustrates a system diagram for implementing an MABAM of FIG. 3 in accordance with an exemplary embodiment.

According to exemplary embodiments, the system 400 may include a platform and language agnostic MABAD 402 within which a platform and language agnostic MABAM 406 is embedded, a server 404, database(s) 412, and a communication network 410.

According to exemplary embodiments, the MABAD 402 including the MABAM 406 may be connected to the server 404 and the database(s) 412 via the communication network 410. The MABAD 402 may also be connected to the plurality of client devices 408(1)-408(n) via the communication network 410, but the disclosure is not limited thereto. The MABAM 406, the server 404, the plurality of client devices 408(1)-408(n), the database(s) 412, the communication network 410 as illustrated in FIG. 4 may be the same or similar to the MABAM 306, the server 304, the plurality of client devices 308(1)-308(n), the database(s) 312, the communication network 310, respectively, as illustrated in FIG. 3.

According to exemplary embodiments, as illustrated in FIG. 4, the MABAM 406 may include a receiving module 414, a generating module 416, a determining module 418, a calculating module 420, a quantifying module 422, an updating module 424, a sampling module 428, an executing module 430, a communication module 432, and a GUI 434.

According to exemplary embodiments, each of the receiving module 414, generating module 416, determining module 418, calculating module 420, quantifying module 422, updating module 424, sampling module 428, executing module 430, and the communication module 432 of the MABAM 406 may be physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies.

According to exemplary embodiments, each of the receiving module 414, generating module 416, determining module 418, calculating module 420, quantifying module 422, updating module 424, sampling module 428, executing module 430, and the communication module 432 of the MABAM 406 may be implemented by microprocessors or similar, and may be programmed using software (e.g., microcode) to perform various functions discussed herein and may optionally be driven by firmware and/or software.

Alternatively, according to exemplary embodiments, each of the receiving module 414, generating module 416, determining module 418, calculating module 420, quantifying module 422, updating module 424, sampling module 428, executing module 430, and the communication module 432 of the MABAM 406 may be implemented by dedicated hardware, or as a combination of dedicated hardware to perform some functions and a processor (e.g., one or more programmed microprocessors and associated circuitry) to perform other functions.

According to exemplary embodiments, each of the receiving module 414, generating module 416, determining module 418, calculating module 420, quantifying module 422, updating module 424, sampling module 428, executing module 430, and the communication module 432 of the MABAM 406 may be called via corresponding API.

The process may be executed via the communication module 432 and the communication network 410, which may comprise plural networks as described above. For example, in an exemplary embodiment, the various components of the MABAM 406 may communicate with the server 404, and the database(s) 412 via the communication module 432 and the communication network 410. Of course, these embodiments are merely exemplary and are not limiting or exhaustive.

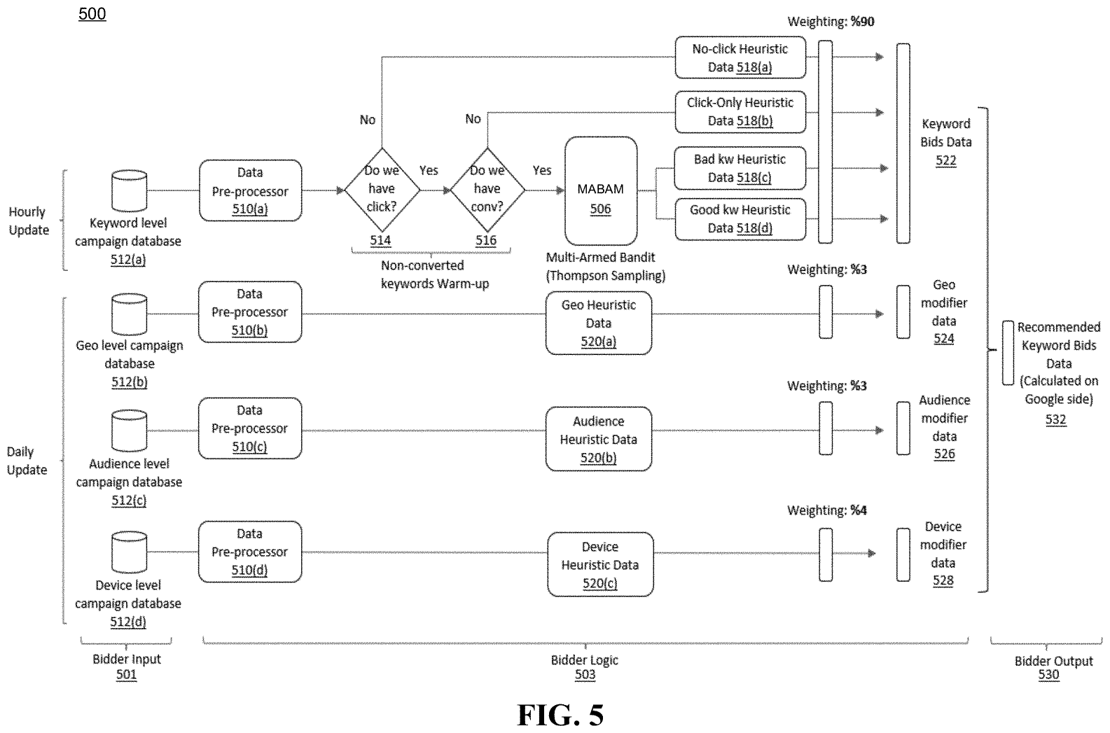

FIG. 5 illustrates an exemplary architecture 500 implemented by the platform and language agnostic MABAM 406 of FIG. 4 in accordance with an exemplary embodiment.

As illustrated in FIG. 5, a data pre-processor 510(a) may be operatively connected to a keyword level campaign database 512(a) to obtain hourly update, or real-time update, or other preconfigured time-based update as desired on keyword level campaign data. A data pre-processor 510(b) may be operatively connected to a geo level campaign database 512(b) to obtain daily update, or real-time update, or other preconfigured time-based update as desired on geo level campaign data (i.e., data on geo locations of certain customers of a certain business). A data pre-processor 510(c) may be operatively connected to an audience level campaign database 512(c) to obtain daily update, or real-time update, or other preconfigured time-based update as desired on audience level campaign data. A data pre-processor 510(d) may be operatively connected to a device level campaign database 512(d) to obtain daily update, or real-time update, or other preconfigured time-based update as desired on device level campaign data.

According to exemplary embodiments, the MABAM 506 as illustrated in FIG. 5 may be the same or similar to the MABAM 406 as illustrated in FIG. 4. Referring to FIGS. 4 and 5, the MABAM 506 may be operatively connected to the data pre-processors 510(a), 510(b), 510(c), and 510(d) via the communication network 410.

As illustrated in FIG. 5, bidder input 501, bidder logic 503 and the bidder output 530 may operatively form a sponsored-search data pipeline, but the disclosure is not limited thereto. For example, the MABAM 406, 506 may be configured to adjust data pipelines in any other desired marketing channels as well.

Referring back to FIGS. 4 and 5, according to exemplary embodiments, the receiving module 414 may be configured to receive bidder input 501 data in the sponsored-search data pipeline. The generating module 416 may be configured to generate keyword-level metrics data based on the received bidder input 501 data that includes CPA data and total spending data for each keyword. The determining module 418 may be configured to determine campaign-level CPA threshold data chosen at previous iteration of search campaign and a target CPA data used for current search campaign. The calculating module 420 may be configured to calculate, in response to determining, campaign-level metrics data that includes the CPA data and adjusted total spending data. The quantifying module 422 may be configured to quantify, in response to calculating, a final campaign-level reward data based on the calculated campaign-level metrics data, adjusted total spending data, and the target CPA data. The updating module 424 may be configured to update, in response to quantifying, a distribution corresponding to CPA-threshold data chosen at previous iteration using the final campaign-level reward data. The sampling module 428 may be configured to sample CPA-threshold distributions and the determining module 418 may be configured to determine CPA-threshold data chosen at current iteration. The executing module 430 may be configured to execute, in response to sampling, campaign-level heuristics using the keyword-level metrics data, campaign-level metrics data, and the CPA-threshold data chosen at current iteration. The MABAM 406, 506 may then display the final heuristic-execution data onto the GUI 434, thereby automating the sponsored-search data pipeline or automating the adjustment of data pipelines in any other desired marketing channels, but the disclosure is not limited thereto.

According to exemplary embodiments, the bidder input 501 data may include hourly update data corresponding to the keyword-level campaign data received from the keyword level campaign database 512(b). In the decision block 514, the determining module 418 determines whether there is a click for a certain keyword. In the decision block 516, the determining module 418 determines whether there is a conversion for the certain keyword.

According to exemplary embodiments, the MABAM 406 may be further configured to apply multi-armed bandit algorithms with the keyword-level campaign data to generate bad keyword heuristic data 518(c) and good keyword heuristic data 518(d) based on determining, in the decision block 514, that there is a click for the certain keyword and that there is a conversion (based on conversion determination made in the decision block 516) of said certain keyword.

According to exemplary embodiments, the generating module 416 may be further configured to generate no-click heuristic data 518(a) based on determining that there is no click for the certain keyword; and generate click-only heuristic data 518(b) based on determining that there is a click for the certain keyword, but there is no conversion for the certain keyword. The generating module 416 may be further configured to generate keyword bids data 522 based on weighted value of each of the no-click heuristic data 518(a), click-only heuristic data 518(b), bad keyword heuristic data 518(c), and the good keyword heuristic data 518(d); and the MABAM 406 may be configured to apply the keywords bids data 522 in calculating the final campaign-level reward data (i.e., recommended keyword bids data 532).

According to exemplary embodiments, the bidder input 501 data may include daily update data corresponding to geo level campaign data received from the geo level campaign database 512(b), audience level campaign data received from the audience level campaign database 512(c), and device level campaign data received from the device level campaign database 512(d). The MABAM 406 may be further configured to apply the multi-armed bandit algorithms with: the geo level campaign data to generate geo heuristic data 520(a), the audience level campaign data to generate audience heuristic data 520(b), and the device level campaign data to generate device heuristic data 520(c). The generating module 416 may be configured to generate a geo modifier data 524 based on a weighted value of the geo heuristic data 520(a); generating an audience modifier data 526 based on a weighted value of the audience heuristic data 520(b); generating a device modifier data 528 based on a weighted value of the device heuristic data 520(c). The MABAM 406 may be configured to apply the geo modifier data 524, the audience modifier data 526, and the device modifier data 528 along with the keyword bids data 522 in calculating the final campaign-level reward data (i.e., recommended keyword bids data 532).

According to exemplary embodiments, the adjusted total spending data may correspond to total under threshold keywords' spending data or total converted keyword spending data.

According to exemplary embodiments, the target CPA data may be set as a guideline for a profitable CPA initiated at campaign level by a LOB based on product profitability.

According to exemplary embodiments, the CPA threshold data may be set as a value representing a percentile of all keywords' CPAs under the same search campaign.

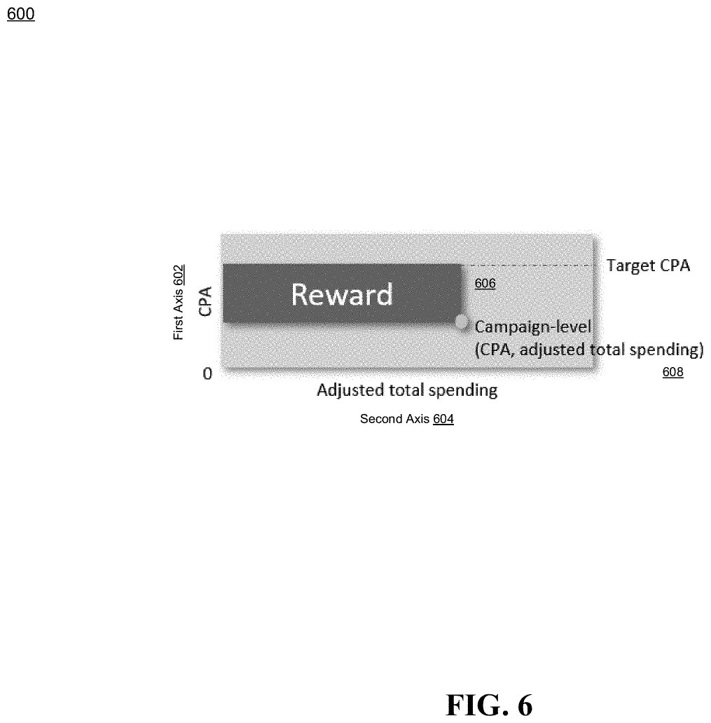

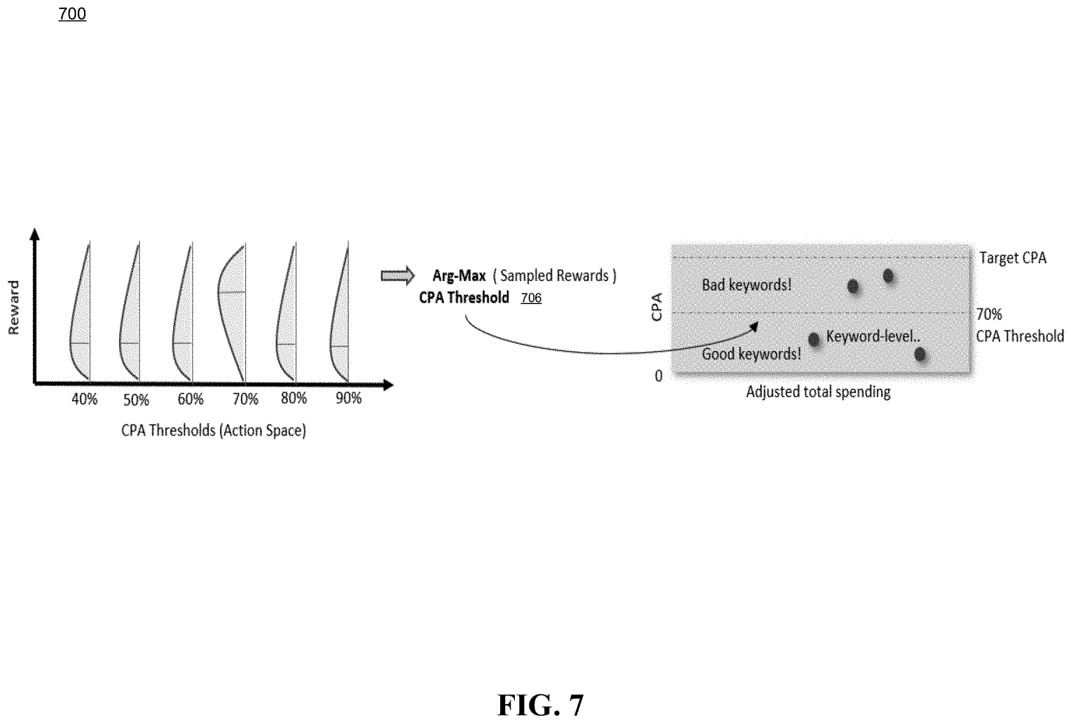

For example, FIG. 6 illustrates a quadrant space 600 which shows an exemplary final campaign-level reward 606 calculated by the MABAM 406, 506 by utilizing corresponding modules as disclosed herein in accordance with an exemplary embodiment. FIG. 7 illustrates an exemplary graph 700 that shows how a CPA threshold 706 is set as the fixed strategy for next iteration of search campaign by the MABAM 406, 506 in accordance with an exemplary embodiment.

Referring back to FIGS. 4, 5, and 6, according to exemplary embodiments, in calculating the final campaign-level reward data (i.e., reward 606 as illustrated in FIG. 6), the MABAM 406, 506 may place previously calculated campaign-level metrics data as a point on a quadrant space 600 formed by the CPA as a first axis 602 of the quadrant space 600 and the adjusted total spending data as a second axis 604 of the quadrant space 600, orthogonal to the first axis 602. The MABAM 406, 506 may place the target CPA data as an intersected line 601 with the first axis 602 on the quadrant; and the calculating module 420 may be configured to calculate the final campaign-level reward data (i.e., reward 606) that represents a rectangular area formed by drawing orthogonal lines from the point to both the first axis 602 and the intersected line 601.

Referring back to FIGS. 4-7, as illustrated in FIG. 7, according to exemplary embodiments, the MABAM 406, 506 may be configured to utilize the calculated final campaign-level reward data (i.e., reward 606) to update corresponding previously used CPA threshold's reward distribution. The sampling module 428 may be configured to sample reward from each CPA threshold arm's posterior distribution and argmax to select a threshold 706 with the largest reward; and the executing module 430 may be configured to set this selected threshold as a fixed strategy for next iteration for search.

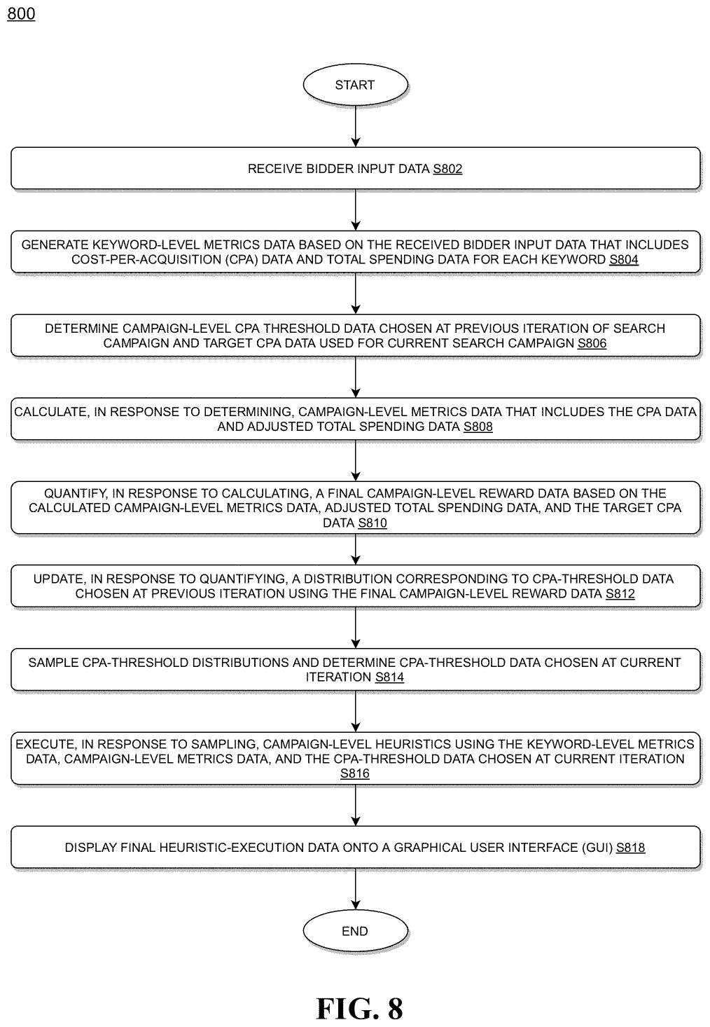

FIG. 8 illustrates an exemplary flow chart 800 implemented by the MABAM 408 of FIG. 4 for automatic real-time identification of dissatisfaction data in accordance with an exemplary embodiment. It will be appreciated that the illustrated process 800 and associated steps may be performed in a different order, with illustrated steps omitted, with additional steps added, or with a combination of reordered, combined, omitted, or additional steps.

As illustrated in FIG. 8, at step S802, the process 800 may include receiving bidder input data in a sponsored-search data pipeline.

At step S804, the process 800 may include generating keyword-level metrics data based on the received bidder input data that includes cost-per-acquisition (CPA) data and total spending data for each keyword.

At step S806, the process 800 may include determining campaign-level CPA threshold data chosen at previous iteration of search campaign and a target CPA data used for current search campaign.

At step S808, the process 800 may include calculating, in response to determining, campaign-level metrics data that includes the CPA data and adjusted total spending data.

At step S810, the process 800 may include quantifying, in response to calculating, a final campaign-level reward data based on the calculated campaign-level metrics data, adjusted total spending data, and the target CPA data.

At step S812, the process 800 may include updating, in response to quantifying, a distribution corresponding to CPA-threshold data chosen at previous iteration using the final campaign-level reward data.

At step S814, the process 800 may include sampling CPA-threshold distributions and determining CPA-threshold data chosen at current iteration.

At step S816, the process 800 may include executing, in response to sampling, campaign-level heuristics using the keyword-level metrics data, campaign-level metrics data, and the CPA-threshold data chosen at current iteration.

At step S818, the process 800 may include displaying the final heuristic-execution data onto a GUI thereby automating the sponsored-search data pipeline or automating the adjustment of data pipelines in any other desired marketing channels, but the disclosure is not limited thereto.

According to exemplary embodiments, the bidder input data may include hourly update data, real-time update data, or other preconfigured time-based update data corresponding to keyword-level campaign data, and the process 800 may further include: applying multi-armed bandit algorithms with the keyword-level campaign data to generate bad keyword heuristic data and good keyword heuristic data based on determining that there is a click for a certain keyword and that there is a conversion of said certain keyword; generating no-click heuristic data based on determining that there is no click for the certain keyword; generating click-only heuristic data based on determining that there is a click for the certain keyword, but there is no conversion for the certain keyword; generating keyword bids data based on weighted value of each of the bad keyword heuristic data, good keyword heuristic data, no-click heuristic data, and click-only heuristic data; and applying the keywords bids data in calculating the final heuristic-execution data.

According to exemplary embodiments, the bidder input data may include daily update data, real-time update data, or other preconfigured time-based update data corresponding to geo level campaign data, audience level campaign data, and device level campaign data, and the process 800 may further include: utilizing the geo level campaign data to generate geo heuristic data; utilizing the audience level campaign data to generate audience heuristic data; and utilizing the device level campaign data to generate device heuristic data. The process 800 may further include generating a geo modifier data based on a weighted value of the geo heuristic data; generating an audience modifier data based on a weighted value of the audience heuristic data; generating a device modifier data based on a weighted value of the device heuristic data; and applying the geo modifier data, the audience modifier data, and the device modifier data along with the keyword bids data in calculating the final heuristic-execution data.

According to exemplary embodiments, in calculating the final campaign-level reward data, the process 800 may further include: placing previously calculated campaign-level metrics data as a point on a quadrant space formed by the CPA as a first axis of the quadrant and the adjusted total spending data as a second axis of the quadrant orthogonal to the first axis; placing the target CPA data as an intersected line with the first axis on the quadrant; and calculating the final campaign-level reward data that represents a rectangular area formed by drawing orthogonal lines from the point to both the first axis and the intersected line.

According to exemplary embodiments, the process 800 may further include: utilizing the calculated final campaign-level reward data to update corresponding previously used CPA threshold's reward distribution; sampling reward from each CPA threshold arm's posterior distribution and argmax to select a threshold with the largest reward; and setting this selected threshold as a fixed strategy for next iteration for search.

According to exemplary embodiments, the MABAD 402 may include a memory (e.g., a memory 106 as illustrated in FIG. 1) which may be a non-transitory computer readable medium that may be configured to store instructions for implementing a MABAM 406, 506 for automating sponsored-search data pipelines as disclosed herein. The MABAD 402 may also include a medium reader (e.g., a medium reader 112 as illustrated in FIG. 1) which may be configured to read any one or more sets of instructions, e.g., software, from any of the memories described herein. The instructions, when executed by a processor embedded within the MABAM 406, 506 or within the MABAD 402, may be used to perform one or more of the methods and processes as described herein. In a particular embodiment, the instructions may reside completely, or at least partially, within the memory 106, the medium reader 112, and/or the processor 104 (see FIG. 1) during execution by the MABAD 402.

According to exemplary embodiments, the instructions, when executed, may cause a processor embedded within the MABAM 406, 506 or the MABAD 402 to perform the following: receiving bidder input data in a sponsored-search data pipeline; generating keyword-level metrics data based on the received bidder input data that includes CPA data and total spending data for each keyword; determining campaign-level CPA threshold data chosen at previous iteration of search campaign and a target CPA data used for current search campaign; calculating, in response to determining, campaign-level metrics data that includes the CPA data and adjusted total spending data; quantifying, in response to calculating, a final campaign-level reward data based on the calculated campaign-level metrics data, adjusted total spending data, and the target CPA data; updating, in response to quantifying, a distribution corresponding to CPA-threshold data chosen at previous iteration using the final campaign-level reward data; sampling CPA-threshold distributions and determining CPA-threshold data chosen at current iteration; executing, in response to sampling, campaign-level heuristics using the keyword-level metrics data, campaign-level metrics data, and the CPA-threshold data chosen at current iteration; and displaying the final heuristic-execution data onto a GUI, thereby automating the sponsored-search data pipeline or automating the adjustment of data pipelines in any other desired marketing channels, but the disclosure is not limited thereto. According to exemplary embodiments, the processor may be the same or similar to the processor 104 as illustrated in FIG. 1 or the processor embedded within MABAD 202, MABAD 302, MABAD 402, and MABAM 406, 506.

According to exemplary embodiments, the bidder input data may include hourly update data, real-time update data, or other preconfigured time-based update data corresponding to keyword-level campaign data, and the instructions, when executed, may further cause the processor 104 to perform the following: applying multi-armed bandit algorithms with the keyword-level campaign data to generate bad keyword heuristic data and good keyword heuristic data based on determining that there is a click for a certain keyword and that there is a conversion of said certain keyword; generating no-click heuristic data based on determining that there is no click for the certain keyword; generating click-only heuristic data based on determining that there is a click for the certain keyword, but there is no conversion for the certain keyword; generating keyword bids data based on weighted value of each of the bad keyword heuristic data, good keyword heuristic data, no-click heuristic data, and click-only heuristic data; and applying the keywords bids data in calculating the final heuristic-execution data.

According to exemplary embodiments, the bidder input data may include daily update data, real-time update data, or other preconfigured time-based update data corresponding to geo level campaign data, audience level campaign data, and device level campaign data, and the instructions, when executed, may further cause the processor 104 to perform the following: utilizing the geo level campaign data to generate geo heuristic data, the audience level campaign data to generate audience heuristic data, and the device level campaign data to generate device heuristic data.

According to the instructions, when executed, may further cause the processor 104 to perform the following: generating a geo modifier data based on a weighted value of the geo heuristic data; generating an audience modifier data based on a weighted value of the audience heuristic data; generating a device modifier data based on a weighted value of the device heuristic data; and applying the geo modifier data, the audience modifier data, and the device modifier data along with the keyword bids data in calculating the final heuristic-execution data.

According to exemplary embodiments, in calculating the final campaign-level reward data, and the instructions, when executed, may further cause the processor 104 to perform the following: placing previously calculated campaign-level metrics data as a point on a quadrant space formed by the CPA as a first axis of the quadrant and the adjusted total spending data as a second axis of the quadrant orthogonal to the first axis; placing the target CPA data as an intersected line with the first axis on the quadrant; and calculating the final campaign-level reward data that represents a rectangular area formed by drawing orthogonal lines from the point to both the first axis and the intersected line.

According to exemplary embodiments, the instructions, when executed, may further cause the processor 104 to perform the following: utilizing the calculated final campaign-level reward data to update corresponding previously used CPA threshold's reward distribution; sampling reward from each CPA threshold arm's posterior distribution and argmax to select a threshold with the largest reward; and setting this selected threshold as a fixed strategy for next iteration for search and applying the selected threshold for further processing.

According to exemplary embodiments as disclosed above in FIGS. 1-8, technical improvements effected by the instant disclosure may include a platform for implementing a platform and language agnostic multi-armed bandit application module for applying multi-armed bandit algorithms for automating sponsored-search data pipelines, thereby allowing different sponsored search heuristics to be automated and scaled in a robust fashion, but the disclosure is not limited thereto. For example, according to exemplary embodiments as disclosed above in FIGS. 1-8, technical improvements effected by the instant disclosure may include a platform for implementing a platform and language agnostic multi-armed bandit application module that allows for applying multi-armed bandit algorithms to more complex problems, such as sponsored search, by having the multi-armed bandit adjust data pipeline parameters instead of directly trying to solve the problem, thereby automating the sponsored-search data pipelines or automating the adjustment of data pipelines in any other desired marketing channels, but the disclosure is not limited thereto.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for automating sponsored-search data pipelines by utilizing one or more processors along with allocated memory, the method comprising:
receiving bidder input data;
generating keyword-level metrics data based on the received bidder input data that includes cost-per-acquisition (CPA) data and total spending data for each keyword;
determining campaign-level CPA threshold data chosen at previous iteration of search campaign and a target CPA data used for current search campaign;
calculating, in response to determining, campaign-level metrics data that includes the CPA data and adjusted total spending data;
quantifying, in response to calculating, a final campaign-level reward data based on the calculated campaign-level metrics data, adjusted total spending data, and the target CPA data;
updating, in response to quantifying, a distribution corresponding to CPA-threshold data chosen at previous iteration using the final campaign-level reward data;
sampling CPA-threshold distributions and determine CPA-threshold data chosen at current iteration;
executing, in response to sampling, campaign-level heuristics using the keyword-level metrics data, campaign-level metrics data, and the CPA-threshold data chosen at current iteration; and
displaying final heuristic-execution data onto a graphical user interface (GUI).

2. The method according to claim 1, wherein the bidder input data includes hourly update data, real-time update data, or other preconfigured time-based update data corresponding to keyword-level campaign data, and the method further comprising:
generating bad keyword heuristic data and good keyword heuristic data based on determining that there is a click for a certain keyword and that there is a conversion of said certain keyword;
generating no-click heuristic data based on determining that there is no click for the certain keyword;
generating click-only heuristic data based on determining that there is a click for the certain keyword, but there is no conversion for the certain keyword;
generating keyword bids data based on weighted value of each of the bad keyword heuristic data, good keyword heuristic data, no-click heuristic data, and click-only heuristic data; and
applying the keywords bids data in calculating the final heuristic-execution data.

3. The method according to claim 2, wherein the bidder input data includes daily update data, real-time update data, or other preconfigured time-based update data corresponding to geo level campaign data, audience level campaign data, and device level campaign data, and the method further comprising:
utilizing the geo level campaign data to generate geo heuristic data; utilizing the audience level campaign data to generate audience heuristic data; utilizing the device level campaign data to generate device heuristic data;
generating a geo modifier data based on a weighted value of the geo heuristic data;
generating an audience modifier data based on a weighted value of the audience heuristic data;
generating a device modifier data based on a weighted value of the device heuristic data; and
applying the geo modifier data, the audience modifier data, and the device modifier data along with the keyword bids data in calculating the final heuristic-execution data.

4. The method according to claim 1, wherein the adjusted total spending data corresponds to total under threshold keywords' spending data or total converted keyword spending data.

5. The method according to claim 1, wherein the target CPA data is set as a guideline for a profitable CPA initiated at campaign level by a line-of-business (LOB) based on product profitability.

6. The method according to claim 1, the CPA threshold data is set as a value representing a percentile of all keywords' CPAs under the same search campaign.

7. The method according to claim 1, in calculating the final campaign-level reward data, the method further comprising:
placing previously calculated campaign-level metrics data as a point on a quadrant space formed by the CPA as a first axis of the quadrant and the adjusted total spending data as a second axis of the quadrant orthogonal to the first axis;
placing the target CPA data as an intersected line with the first axis on the quadrant; and
calculating the final campaign-level reward data that represents a rectangular area formed by drawing orthogonal lines from the point to both the first axis and the intersected line.

8. The method according to claim 7, further comprising:
utilizing the calculated final campaign-level reward data to update corresponding previously used CPA threshold's reward distribution;
sampling reward from each CPA threshold arm's posterior distribution and argmax to select a threshold with the largest reward; and
setting this selected threshold as a fixed strategy for next iteration for search.

9. A system for automating sponsored-search data pipelines, the system comprising:
a processor; and
a memory operatively connected to the processor via a communication interface, the memory storing computer readable instructions, when executed, causes the processor to:
receive bidder input data in a sponsored-search data pipeline;
generate keyword-level metrics data based on the received bidder input data that includes cost-per-acquisition (CPA) data and total spending data for each keyword;
determine campaign-level CPA threshold data chosen at previous iteration of search campaign and target CPA data used for current search campaign;
calculate, in response to determining, campaign-level metrics data that includes the CPA data and adjusted total spending data;
quantify, in response to calculating, a final campaign-level reward data based on the calculated campaign-level metrics data, adjusted total spending data, and the target CPA data;
update, in response to quantifying, a distribution corresponding to CPA-threshold data chosen at previous iteration using the final campaign-level reward data;
sample CPA-threshold distributions and determine CPA-threshold data chosen at current iteration;
execute, in response to sampling, campaign-level heuristics using the keyword-level metrics data, campaign-level metrics data, and the CPA-threshold data chosen at current iteration; and
displaying final heuristic-execution data onto a graphical user interface (GUI).

10. The system according to claim 9, wherein the bidder input data includes hourly update data, real-time update data, or other preconfigured time-based update data corresponding to keyword-level campaign data, and the processor is further configured to:
generate bad keyword heuristic data and good keyword heuristic data based on determining that there is a click for a certain keyword and that there is a conversion of said certain keyword;
generate no-click heuristic data based on determining that there is no click for the certain keyword;
generate click-only heuristic data based on determining that there is a click for the certain keyword, but there is no conversion for the certain keyword;
generate keyword bids data based on weighted value of each of the bad keyword heuristic data, good keyword heuristic data, no-click heuristic data, and click-only heuristic data; and
apply the keywords bids data in calculating the final heuristic-execution data.

11. The system according to claim 10, wherein the bidder input data includes daily update data, real-time update data, or other preconfigured time-based update data corresponding to geo level campaign data, audience level campaign data, and device level campaign data, and the processor is further configured to:
utilize the geo level campaign data to generate geo heuristic data; utilize the audience level campaign data to generate audience heuristic data; utilize the device level campaign data to generate device heuristic data;
generate a geo modifier data based on a weighted value of the geo heuristic data;
generate an audience modifier data based on a weighted value of the audience heuristic data; and
generate a device modifier data based on a weighted value of the device heuristic data;
apply the geo modifier data, the audience modifier data, and the device modifier data along with the keyword bids data in calculating the final heuristic-execution data.

12. The system according to claim 9, wherein the adjusted total spending data corresponds to total under threshold keywords' spending data or total converted keyword spending data.

13. The system according to claim 9, wherein the target CPA data is set as a guideline for a profitable CPA initiated at campaign level by a line-of-business (LOB) based on product profitability.

14. The system according to claim 9, the CPA threshold data is set as a value representing a percentile of all keywords' CPAs under the same search campaign.

15. The system according to claim 9, in calculating the final campaign-level reward data, the processor is further configured to:
place previously calculated campaign-level metrics data as a point on a quadrant space formed by the CPA as a first axis of the quadrant and the adjusted total spending data as a second axis of the quadrant orthogonal to the first axis;
place the target CPA data as an intersected line with the first axis on the quadrant; and
calculate the final campaign-level reward data that represents a rectangular area formed by drawing orthogonal lines from the point to both the first axis and the intersected line.

16. The system according to claim 15, the processor is further configured to:
utilize the calculated final campaign-level reward data to update corresponding previously used CPA threshold's reward distribution;
sample reward from each CPA threshold arm's posterior distribution and argmax to select a threshold with the largest reward; and
set this selected threshold as a fixed strategy for next iteration for search.

17. A non-transitory computer readable medium configured to store instructions for automating sponsored-search data pipelines, wherein, when executed, the instructions cause a processor to perform the following:
receiving bidder input data in a sponsored-search data pipeline;
generating keyword-level metrics data based on the received bidder input data that includes cost-per-acquisition (CPA) data and total spending data for each keyword;
determining campaign-level CPA threshold data chosen at previous iteration of search campaign and target CPA data used for current search campaign;
calculating, in response to determining, campaign-level metrics data that includes the CPA data and adjusted total spending data;
quantifying, in response to calculating, a final campaign-level reward data based on the calculated campaign-level metrics data, adjusted total spending data, and the target CPA data;
updating, in response to quantifying, a distribution corresponding to CPA-threshold data chosen at previous iteration using the final campaign-level reward data;
sampling CPA-threshold distributions and determine CPA-threshold data chosen at current iteration;
executing, in response to sampling, campaign-level heuristics using the keyword-level metrics data, campaign-level metrics data, and the CPA-threshold data chosen at current iteration; and
displaying final heuristic-execution data onto a graphical user interface (GUI).

18. The non-transitory computer readable medium according to claim 17, wherein the bidder input data includes hourly update data, real-time update data, or other preconfigured time-based update data corresponding to keyword-level campaign data, and when executed, the instructions cause the processor to further perform the following:
generating bad keyword heuristic data and good keyword heuristic data based on determining that there is a click for a certain keyword and that there is a conversion of said certain keyword;
generating no-click heuristic data based on determining that there is no click for the certain keyword;
generating click-only heuristic data based on determining that there is a click for the certain keyword, but there is no conversion for the certain keyword;
generating keyword bids data based on weighted value of each of the bad keyword heuristic data, good keyword heuristic data, no-click heuristic data, and click-only heuristic data; and
applying the keywords bids data in calculating the final heuristic-execution data.

19. The non-transitory computer readable medium according to claim 18, wherein the bidder input data includes daily update data, real-time update data, or other preconfigured time-based update data corresponding to geo level campaign data, audience level campaign data, and device level campaign data, and when executed, the instructions cause the processor to further perform the following:
utilizing the geo level campaign data to generate geo heuristic data; utilizing the audience level campaign data to generate audience heuristic data; utilizing the device level campaign data to generate device heuristic data;
generating a geo modifier data based on a weighted value of the geo heuristic data;
generating an audience modifier data based on a weighted value of the audience heuristic data;
generating a device modifier data based on a weighted value of the device heuristic data; and
applying the geo modifier data, the audience modifier data, and the device modifier data along with the keyword bids data in calculating the final heuristic-execution data.

20. The non-transitory computer readable medium according to claim 18, in calculating the final campaign-level reward data, the instructions, when executed, cause the processor to further perform the following:
placing previously calculated campaign-level metrics data as a point on a quadrant space formed by the CPA as a first axis of the quadrant and the adjusted total spending data as a second axis of the quadrant orthogonal to the first axis;
placing the target CPA data as an intersected line with the first axis on the quadrant; and
calculating the final campaign-level reward data that represents a rectangular area formed by drawing orthogonal lines from the point to both the first axis and the intersected line.
